(19) United States
(12) Patent Application Publication
(10) Pub. No.: US 2019/0010941 A1
(43) Pub. Date: Jan. 10, 2019

(54) SEALING STRUCTURE OF RECIPROCATING PLUNGER PUMP

(71) Applicants: Xiaorong Li, Taizhou (CN); Fazheng Yang, Taizhou (CN); Zhenxing Ying, Taizhou (CN); Bo Chen, Taizhou (CN)

(72) Inventors: Xiaorong Li, Taizhou (CN); Fazheng Yang, Taizhou (CN); Zhenxing Ying, Taizhou (CN); Bo Chen, Taizhou (CN)

(73) Assignee: Zhejiang Rongpeng Air Tools Co., Ltd.

(21) Appl. No.: 15/643,497

(22) Filed: Jul. 7, 2017

(51) Int. Cl. F04B 53/14; F16J 15/3212; F16J 15/3232; F16J 15/00

(52) U.S. Cl. CPC F04B 53/143; F16J 15/002; F16J 15/3232; F16J 15/3212

(57) ABSTRACT

A sealing structure of a reciprocating plunger pump, comprising a pump seat, a pump body assembly, a first sealing ring, and a second sealing ring; the first sealing ring including a first sealing body which is an integrally formed annular body structure including an upper layer, a lower layer, and a V-shaped groove; wherein the V-shaped groove divides the bottom surface of the lower layer into an inner portion and an outer portion, and the inner portion thereof is higher than the outer portion; the second sealing ring includes a second sealing body which is integrally formed and includes an upper ring piece and a lower ring piece having an included angle disposed therebetween; the sealing body includes an annular rib disposed in the middle of an outer wall thereof. The sealing structure allows the reciprocating plunger pump to have a good sealing effect and a long service life.

### BACKGROUND OF THE INVENTION

### (1) Field of the Invention

The present invention relates to a sealing structure of a reciprocating plunger pump.

### (2) Description of the Related Art

High-pressure spray widely used in the home latex paint spray, waterproof, anti-corrosion, steel corrosion and other spraying operations, compared to the traditional artificial spray, which greatly improves the efficiency and reduce labor intensity. Spraying machine, the core component is the plunger pump, and the core components of the plunger pump are plunger rod and sealing ring which are the wearing parts, therefore, how to extend the service life of plunger rod and sealing ring has become a major issue in the art.

### SUMMARY OF THE INVENTION

The technical problem to be solved by the present invention is to provide a sealing structure of a reciprocating plunger pump, which can extend the service life of the sealing ring and reduce the maintenance cost.

In order to solve the above technical problems, the technical solution is to provide a sealing structure of a reciprocating plunger pump, comprising a pump seat, a pump body assembly disposed at a bottom of the pump seat, a hole disposed in the pump seat, a plunger rod installed inside the hole, a first sealing ring disposed in a small retaining groove of the plunger rod, and a second sealing ring disposed in a large retaining groove of the plunger rod; the first sealing ring includes a first sealing body which is an integrally formed annular body structure including an upper layer, a lower layer, and a V-shaped groove disposed on a bottom surface of the lower layer; the V-shaped groove divides the bottom surface of the lower layer into an inner portion and an outer portion, and the inner portion thereof is higher than the outer portion; the V-shaped groove includes a V-shaped tension spring disposed therein and support edges disposed between an opening of the V-shaped groove and the bottom surface of the lower layer, and the V-shaped tension spring having edges are disposed on the support edges; the upper layer having an inner wall and an outer wall are flat structures, and the lower layer having an inner wall and an outer wall are saw-tooth sealing lips. The second sealing ring includes a second sealing body which is integrally formed and includes an upper ring piece and a lower ring piece having an included angle disposed therebetween so that the second sealing body is engaged with the outer surface of the plunger rod; the sealing body includes an annular rib disposed in the middle of an outer wall thereof, and the annular rib divides the outer wall of the second sealing body into an upper mounting portion and a lower mounting portion, the upper mounting portion includes an upper O-ring and the lower mounting portion includes a lower O-ring, the outer wall of the upper O-ring and the lower O-ring is matched on the wall of the large retaining groove, and the upper O-ring and the lower O-ring have a constant inward contraction force.

More preferably, the upper ring piece and the lower ring piece are vertically symmetrical and are fitted with an annular groove on the side of the plunger rod; the side of the plunger rod at the junction between the upper ring piece and the lower ring piece includes an annular resilient groove.

The technical effect achieved by the present invention is:

Compared with the prior art, the first sealing ring of the sealing structure of the reciprocating plunger pump of the present invention forms a seal through the interference fit and the V-shaped tension spring, and the outer wall forms a seal with the small retaining groove of the pump seat, and the inner wall forms a seal with the plunger rod; when the saw-tooth sealing lip is used in low pressure, the pressure of the first sealing ring will be reduced and the wear will be reduced, so that the service life of the small seal is prolonged; when the saw-tooth sealing lip is used in high pressure, the pressure of the first sealing ring will be increased, and the inner and outer walls of the first sealing ring will be expanded, thereby achieving the better sealing effect.

Compared with the prior art, the second sealing body of the second sealing ring of the sealing structure includes two O-rings, the second sealing body includes the upper and lower ring pieces which are vertically symmetrical sealing structures, the annular resilient groove enables the inner wall of the sealing body to be tightly attached to the outer wall of the plunger rod; when the inner wall of the second sealing body is worn, the O-ring will replenishes the wear with an interference fit, whereby the sealing effect is twice the service life of conventional sealing structure, reducing maintenance costs.

### BRIEF DESCRIPTION OF DRAWINGS

FIG. 1 is a schematic view of a sealing structure of a reciprocating plunger pump of the present invention;

FIG. 2 is a cross-sectional view taken along line A-A of FIG. 1;

FIG. 3 is a schematic view of a first sealing ring according to the present invention;

FIG. 4 is a schematic view of a second sealing ring according to the present invention.

### DETAILED DESCRIPTION OF THE INVENTION

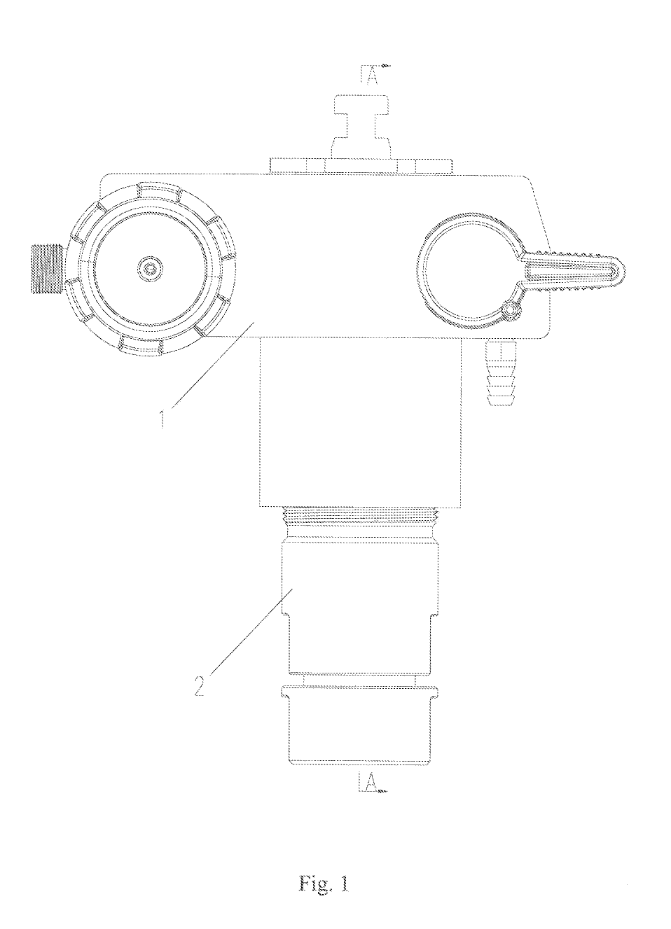

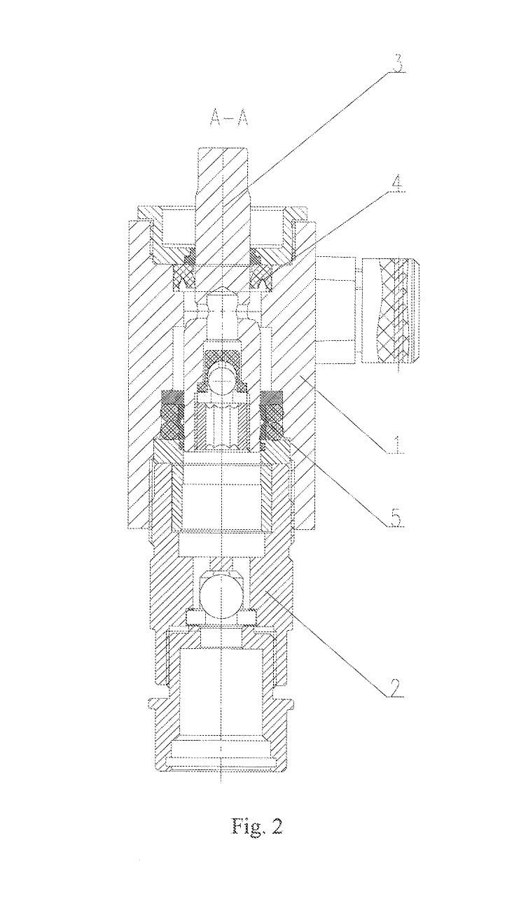

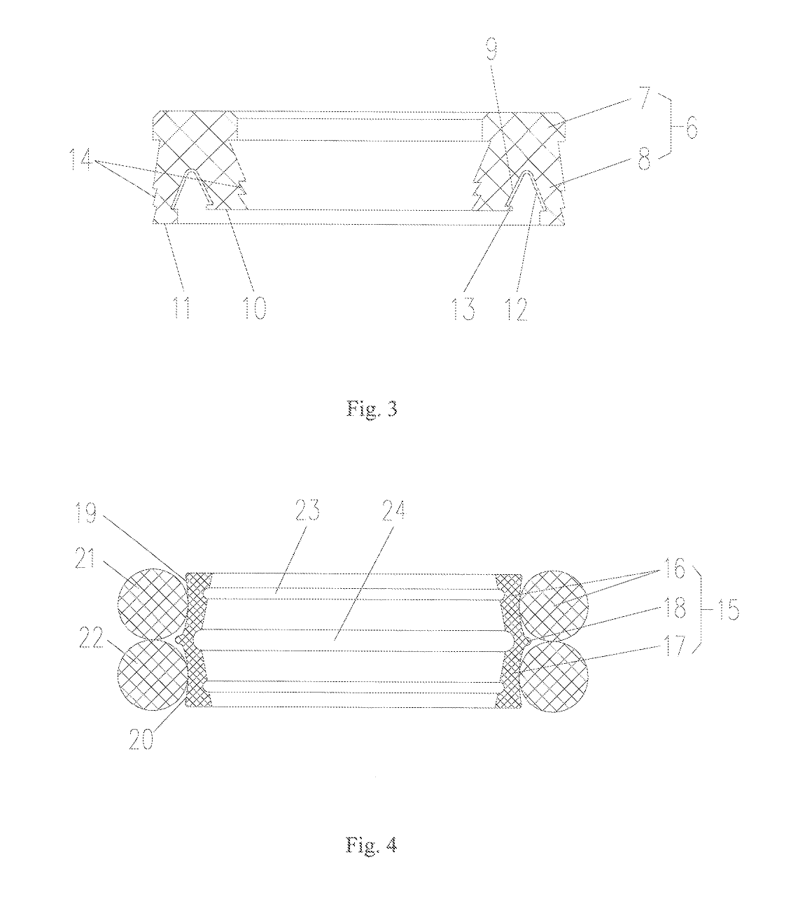

Referring to FIGS. 1-4, the present invention provides a sealing structure of a reciprocating plunger pump, comprising a pump seat (1), a pump body assembly (2) disposed at a bottom of the pump seat (1), a hole disposed in the pump seat (1), a plunger rod (3) installed inside the hole, a first sealing ring (4) disposed in a small retaining groove of the plunger rod (3), and a second sealing ring (5) disposed in a large retaining groove of the plunger rod (3); the first sealing ring (4) includes a first sealing body (6) which is an integrally formed annular body structure including an upper layer (7), a lower layer (8), and a V-shaped groove (9) disposed on a bottom surface of the lower layer (8); the V-shaped groove (9) divides the bottom surface of the lower layer (8) into an inner portion (10) and an outer portion (11), and the inner portion (10) thereof is higher than the outer portion (11); the V-shaped groove (9) includes a V-shaped tension spring (12) disposed therein and support edges (13) disposed between an opening of the V-shaped groove (9) and the bottom surface of the lower layer (8), and the V-shaped tension spring (12) having edges are disposed on the support edges (13); the upper layer (7) having an inner wall and an outer wall are flat structures, and the lower layer (8) having an inner wall and an outer wall are saw-tooth sealing lips (14). The second sealing ring (5) includes a second sealing body (15) which is integrally formed and includes an upper ring piece (16) and a lower ring piece (17) having an included angle disposed therebetween so that the second sealing body (15) is engaged with the outer surface of the plunger rod (3); the sealing body (15) includes an annular rib (18) disposed in the middle of an outer wall thereof, and the annular rib (18) divides the outer wall of the second sealing body (15) into an upper mounting portion (19) and a lower mounting portion (20), the upper mounting portion (19) includes an upper O-ring (21) and the lower mounting portion (20) includes a lower O-ring (22), the outer wall of the upper O-ring (21) and the lower O-ring (22) is matched on the wall of the large retaining groove, and the upper O-ring (21) and the lower O-ring (22) have a constant inward contraction force.

The upper ring piece (16) and the lower ring piece (17) are vertically symmetrical and are fitted with an annular groove (23) on the side of the plunger rod (3); the side of the plunger rod (3) at the junction between the upper ring piece (16) and the lower ring piece (17) includes an annular resilient groove (24).

The following describes the working principle of the present invention:

The outer wall of the first sealing ring (4) is attached to the small retaining groove and the inner wall thereof is attached to the outer wall of the plunger rod (3); the inner wall of the second sealing body (15) of the second sealing ring (5) is attached to the outer wall of the plunger rod (3), and the outer wall of the O-ring (21) and the lower O-ring (22) is attached to the large retaining groove to form a sealing structure of the plunger rod (3) and the pump seat (1). During the operation of the reciprocating plunger pump, as the pressure in the pump seat (1) becomes larger and larger, the pressure of the plunger rod (3) to the second sealing ring (5) and the first sealing ring (4) is gradually increased, the greater the pressure on the first sealing ring (4), the better the sealing effect; the inner wall and the outer wall of the first sealing ring (4) are tightly attached to the outer wall of the plunger rod (3) and the small retaining groove, respectively, by the reaction force of the V-shaped tension spring (12); when the second sealing ring (5) is under the pressure, the O-ring (21) and the lower O-ring (22) are able to replenish the wear of the inner wall of the second sealing body (15) with an interference fit, so that the inner wall of the second sealing ring (5) is always kept sealed with the plunger rod (3). In addition, the upper ring piece 16 and the lower ring piece 17 having the included angle have an elastic force that outwardly arches and expands the upper O-ring (21) and the lower O-ring (22) outwardly, whereby the upper O-ring (21) and the lower O-ring (22) can always be attached to the large retaining groove, and the seal life is greatly extended. Compared with the conventional sealing structure, the sealing structure of the reciprocating plunger pump of the invention has the advantages of long service life and good sealing effect.

The above only describes some exemplary embodiments of the present invention. Those having ordinary skills in the art may also make many modifications and improvements without departing from the conception of the invention, which shall all fall within the protection scope of the invention.

I claim:

1. a sealing structure of a reciprocating plunger pump, comprising a pump seat (1), a pump body assembly (2) disposed at a bottom of the pump seat (1), a hole disposed in the pump seat (1), a plunger rod (3) installed inside the hole, a first sealing ring (4) disposed in a small retaining groove of the plunger rod (3), and a second sealing ring (5) disposed in a large retaining groove of the plunger rod (3);
wherein the first sealing ring (4) includes a first sealing body (6) which is an integrally formed annular body structure including an upper layer (7), a lower layer (8), and a V-shaped groove (9) disposed on a bottom surface of the lower layer (8);
wherein the V-shaped groove (9) divides the bottom surface of the lower layer (8) into an inner portion (10) and an outer portion (11), and the inner portion (10) thereof is higher than the outer portion (11); the V-shaped groove (9) includes a V-shaped tension spring (12) disposed therein and support edges (13) disposed between an opening of the V-shaped groove (9) and the bottom surface of the lower layer (8), and the V-shaped tension spring (12) having edges are disposed on the support edges (13); the upper layer (7) having an inner wall and an outer wall are flat structures, and the lower layer (8) having an inner wall and an outer wall are saw-tooth sealing lips (14);
wherein the second sealing ring (5) includes a second sealing body (15) which is integrally formed and includes an upper ring piece (16) and a lower ring piece (17) having an included angle disposed therebetween, so that the second sealing body (15) is engaged with the outer surface of the plunger rod (3);
wherein the sealing body (15) includes an annular rib (18) disposed in the middle of an outer wall thereof, and the annular rib (18) divides the outer wall of the second sealing body (15) into an upper mounting portion (19) and a lower mounting portion (20), the upper mounting portion (19) includes an upper O-ring (21) and the lower mounting portion (20) includes a lower O-ring (22), the outer wall of the upper O-ring (21) and the lower O-ring (22) is matched on the wall of the large retaining groove, and the upper O-ring (21) and the lower O-ring (22) have a constant inward contraction force.

2. The sealing structure of the reciprocating plunger pump according to claim 1, wherein the upper ring piece (16) and the lower ring piece (17) are vertically symmetrical and are fitted with an annular groove (23) on the side of the plunger rod (3); the side of the plunger rod (3) at the junction between the upper ring piece (16) and the lower ring piece (17) includes an annular resilient groove (24).
